(19) United States
(12) Patent Application Publication
(10) Pub. No.: US 2020/0148103 A1
(43) Pub. Date: May 14, 2020

(54) SELECTIVELY ILLUMINATED AREA OF AN INSTRUMENT PANEL GAUGE

(71) Applicant: Continental Automotive Systems, Inc., Auburn Hills, MI (US)

(72) Inventors: Curt Ollila, Fenton, MI (US); Vyacheslav Birman, Auburn Hills, MI (US)

(21) Appl. No.: 16/190,969

(22) Filed: Nov. 14, 2018

(51) Int. Cl. B60Q 3/14; B60K 37/02; B60Q 3/16; G12B 11/02; B60Q 3/64

(52) U.S. Cl. CPC B60Q 3/14; B60K 37/02; B60Q 3/64; G12B 11/02; B60Q 3/16

(57) ABSTRACT

Two separate and differently-colored light sources provide correspondingly-colored light into corresponding light guides that extend part way around the perimeter of a gauge, such as a tachometer dial and adjacent to numerals or digits that correspond to a measured quantity, such as a too-high engine speed range and an energy-saving or “eco” speed range.

### BACKGROUND

As used herein, the term “gauge” refers to an instrument with a graduated scale or dial for indicating quantity. Vehicle instrument panels have a plethora of gauges, examples of which include a fuel gauge, a speedometer and a tachometer.

Some gauges have a graduated scale or a dial that is permanently marked with indicia indicating a particular quantity or a quantity range that a motor vehicle operator should be made aware of. Tachometers for example have a marked “recline” range of engine speeds and a fuel-efficient, economy or “eco” range printed on the dial or an applique. As is known, permanent markings on a gauge are sometimes unable to alert a driver's attention because those permanent markings eventually lose their visual importance much like a warning light or indicator that is always on and which is eventually ignored. A gauge, including a tachometer, which is better able to alert a driver to important quantities like engine speed ranges would be an improvement over the prior art.

### BRIEF DESCRIPTION OF THE FIGURES

FIG. 1 depicts a tachometer indicating a fuel-efficient engine speed range;

FIG. 2 depicts the tachometer indicating a “recline” engine speed range;

FIG. 3 is a sectional view of a tachometer shown in FIG. 1 and FIG. 2 with differently-colored light guides configured to illuminate when the tachometer pointer is directed at them;

FIG. 4 depicts a light guide showing cuts in the backside to improve front side illumination; and

FIG. 5 depicts a light guide showing a foil attached to the backside to improve illumination from the front side.

### DETAILED DESCRIPTION

For illustration purposes, the figures depict a tachometer as an exemplar of a gauge having areas that are selectively illuminated to notify a driver of certain engine conditions. Those of ordinary skill in the art should appreciate that the apparatus described herein and depicted in the figures can be used with gauges other than tachometers by appropriate modification of the device shown in the figures and described below.

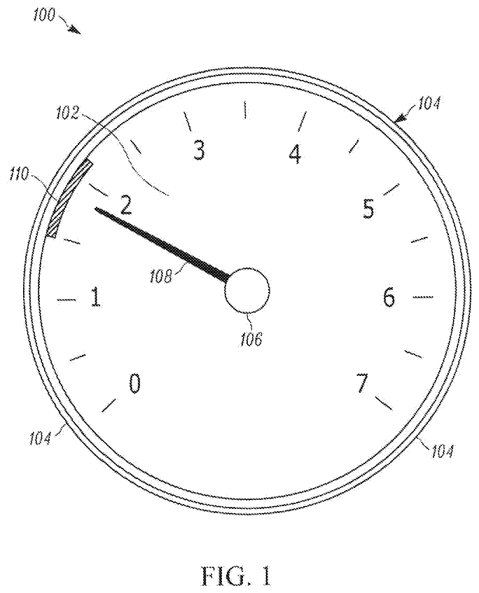

FIG. 1 depicts a tachometer 100 having a dial 102 and a peripheral edge 104. The dial 102 is essentially circular. The peripheral edge 104 of the dial 102 has the same shape. The edge 104 is considered herein as having a contour which is convex.

The dial 102 has a center point 106 from which extends a pointer 108. The pointer 108, points to or identifies a location or region on the peripheral edge 104 marked with graphics. i.e., numerals, which indicate engine speed. A first engine speed indicator 110, preferably green, marks an engine speed range considered to be a fuel-efficient range for the vehicle.

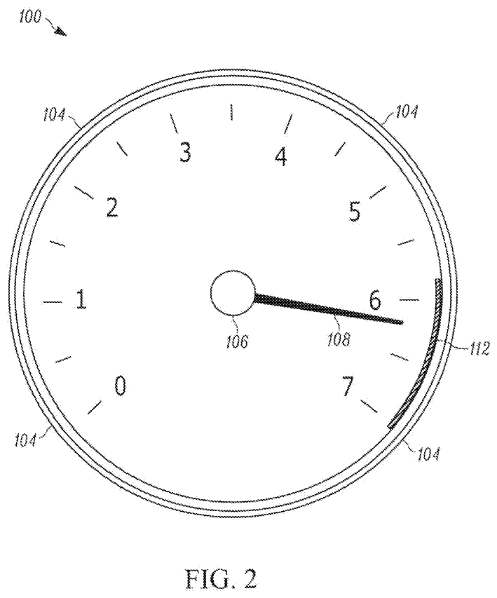

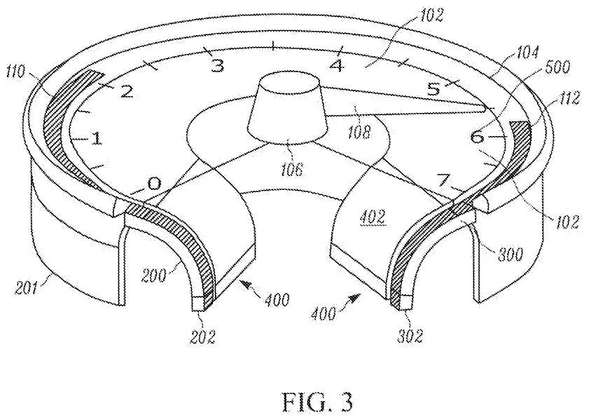

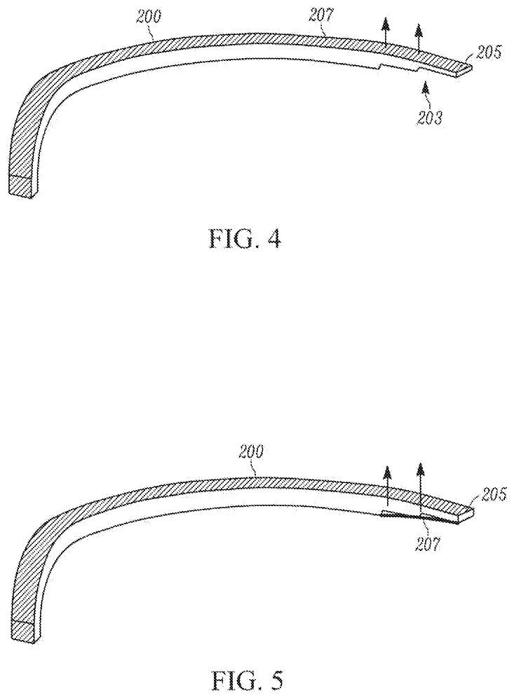

FIG. 2 depicts the same tachometer with the same physical characteristics but with a second and different engine speed indicator 112, preferably red, indicating an engine speed too high for safe engine operation. The different engine speed indicators 110 and 112 turn on, i.e., they are illuminated, when the pointer 108 is directed at the particular engine speed indicators and thus notify a driver more effectively than a painted applique. Selectively illuminated regions on the perimeter 104 between which the engine speed color indicators extend, are provided by an apparatus shown in FIG. 3.

The apparatus shown in FIG. 3 comprises the dial 102 shown above and its peripheral edge 104 as well as the pointer 108 but it also includes two light guides 200 and 300, all of which are inside a housing 201. On the left side, the green-colored light guide 200 has a bottom surface 204 that receives green-colored light emitted by a green LED 202 located at the bottom surface 204 of the light guide 200. As is well known, the light guide 200 propagates light through it. The shape of the light guide is fashioned such that green light is emitted adjacent to the peripheral edge of the dial between first and second spaced apart locations around the dial's convex contour which correspond to engine speeds that are considered to be economical.

On the right side of the tachometer, a light guide 300 receives red-colored light from a red LED 302. As with the green light guide, red light is emitted from the light guide 300 in a region outside the peripheral edge between third and fourth different locations on the convex contour.

The red and green LEDs are powered on or “lit” by electronic circuitry that detects when the engine speed is either in an economical range or above a “recline” value and to which the pointer 108 is pointing under the control of other circuitry and a drive motor. The electronic circuitry that controls the LEDs is not germane to the invention claimed hereinafter and therefore not disclosed.

Still referring to FIG. 3, in a preferred embodiment, white LEDs 400 provide light into a backlight light guide 402 which provides backlight illumination to graphics on the dial. The graphics 500, which are digits or numerals for a tachometer, are cut or etched into the dial 102. The backlight light guide 402 thus provides a white or other colored illumination to the graphics that indicate an engine speed.

Referring now to FIG. 5, the green light guide 200 is shown with undercuts 203 at the distal end 205. The undercuts 203 improve the dispersion of light from the opposite side 207 and thus improve the illumination of the green-eco range of the engine speed.

FIG. 5 shows an alternate embodiment for improving the light emitted from the light guides. In FIG. 5, a foil 207 is applied to the backside of the light guide 200 that improves the reflection of light from the light guide and the brightness of the light emitted therefrom.

In a preferred embodiment, the backlight wave guide is a segment of an annulus, the width of which is at least great enough to provide backlight illumination for the graphics 500 cut into the dial 102. The dial itself is therefore a segment of an annulus. The graphics 500 are considered to be “windows” through which light is emitted. Each of the windows is considered to have a shape that is a numeral.

The foregoing description is for purposes of illustration only. As stated above, the apparatus described above and shown in the figures can be readily used with a fuel gauge, a battery charge indicator gauge, a speedometer, engine temperature gauge or any other gauge. The true scope of the invention is therefore set forth in the following claims.

1. A gauge having a selectively illuminated areas to enunciate different quantities, engine speed ranges with different-color indicators, the gauge comprising:
a dial having a center and a peripheral edge, the peripheral edge having a first convex-shaped contour;
a pointer extending from the center of the dial towards the peripheral edge, the pointer being configured to point to at least one of: a location on the peripheral edge and a graphic on the dial, either of which indicates a first quantity;
a first light guide, which conforms to a first portion of the first convex-shaped contour, the first light guide being located outside but adjacent the peripheral edge and extending between first and second spaced apart locations on the first convex-shaped contour, the first light guide emitting a first colored light when the pointer is directed to a location on the peripheral edge that is between the first and second locations on the peripheral edge; and
a second light guide, which conforms to a second portion of the first convex-shaped contour, the second light guide being located outside the peripheral edge and extending between third and fourth locations on the first convex-shaped contour, the second light guide emitting a second colored light when the pointer is directed to a location on the peripheral edge that is between the third and fourth locations on the peripheral edge, the first light guide is a separate body from the second light guide.

2. The gauge of claim 1, wherein the gauge is a tachometer and wherein the first quantity is an engine rotation speed.

3. The gauge of claim 1, wherein the gauge is a fuel gauge.

4. The gauge of claim 1, wherein the gauge is a speedometer.

5. The gauge of claim 1, wherein the gauge is a battery charge indicator.

6. The gauge of claim 1, wherein the gauge is a temperature indicator.

7. The gauge of claim 2, wherein the convex-shaped contour is substantially circular.

8. (canceled)

9. The gauge of claim 2, wherein the first light guide is configured to emit a green light.

10. The gauge of claim 2, wherein the second light guide is configured to emit a red light.

11. The gauge of claim 2, wherein the dial comprises:
a segment of an annulus;
a light guide under the segment of an annulus, which is also a segment of an annulus, the light guide being configured to emit light;
wherein the segment of an annulus has a plurality of windows that are cut through the dial; and
wherein each window cut through the dial has a shape that is a numeral.

12. The gauge of claim 1, wherein the second colored light is a different color from the first colored light.

13. The gauge of claim 12, wherein the first colored light is red and the second colored light is green.

14. The gauge of claim 1, wherein the first, second, third, and fourth locations on the peripheral edge are fixed.

15. The gauge of claim 14, wherein the first and second locations are spaced apart from the third and fourth locations.

16. The gauge of claim 1, wherein a backlight light guide illuminates the graphic on the dial.

17. The gauge of claim 15, wherein the backlight light guide is a segment of an annulus.

18. The gauge of claim 15, wherein the graphic is illuminated white.

19. The gauge of claim 15, wherein the graphic is illuminated a backlight color that is different from the first and second colored lights.
